(19) United States
(12) Patent Application Publication
(10) Pub. No.: US 2024/0418671 A1
(43) Pub. Date: Dec. 19, 2024

(54) ELECTROLYTES WITH ZEOLITES AND YTTRIA-STABILIZED ZIRCONIA FOR MONO-NITROGEN OXIDE SENSORS

(71) Applicant: Saudi Arabian Oil Company, Dhahran (SA)

(72) Inventor: Khawlah Kharashi, Thuwal (SA)

(21) Appl. No.: 18/334,827

(22) Filed: Jun. 14, 2023

(51) Int. Cl. G01N 27/407

(52) U.S. Cl. CPC G01N 27/4074

(57) ABSTRACT

This disclosure relates to electrolyte compositions including a zeolite, yttria-stabilized zirconia (YSZ), and carbon nanotubes for mono-nitrogen oxide (NOx) sensors, and methods of determining the total NOx content in a gas stream using said NOx sensors.

### TECHNICAL FIELD

This document relates to electrolyte compositions including a zeolite, yttria-stabilized zirconia (YSZ), and carbon nanotubes for mono-nitrogen oxide (NOx) sensors. This document also relates to methods of determining the total NOx content in a gas stream using said NOx sensors.

### BACKGROUND

Mono-nitrogen oxides (NOx), the combination of nitric oxide (NO) and nitrous oxide (NO₂) gases, are a major atmosphere pollutant. Notably, NOx contribute to the formation of acid rain and photochemical smog, and can affect tropospheric ozone levels. NOx gases can be formed from the reaction between nitrogen (N₂) and oxygen (O₂) in high temperature settings, such as in car engines during the combustion of fuels. In addition to contributing to environmental pollution, NOx pose a threat to human health and safety. For example, prolonged exposure to NOx has been shown to trigger asthma symptoms, and has been linked to a number of non-respiratory diseases and disorders, such as heart disease and diabetes. It is therefore important to develop high performance and robust sensors, which can accurately determine the concentration of NOx in the air to protect our life and the environment.

NOx sensors typically work by first passing a gas stream over a catalytic filter to form an equilibrium mixture of NO and NO₂. The resulting equilibrium mixture is exposed to the sensor, which determines the total NOx content in the gas stream by comparing the resulting potential difference with a calibration curve. Existing NOx sensors often include a porous electrolyte with embedded electrodes made of a metal. For example, Kharashi and Murray reported an electrolyte composition including partially stabilized yttria (PSZ) and aluminum oxide (Al₂O₃) which detected NO concentrations as low as 5 ppm at 650° C. (K. Kharashi and E. P. Murray, “Effect of Al2O3 in Porous Zirconia Electrolytes for NO Sensing,” J. Electrochem. Soc., vol. 163, no. 13, p. B633, September 2016). While the introduction of aluminum oxide increased the sensitivity of the sensor, it decreased the porosity of the electrolyte composition, which decreases the electrical response of the sensor. Another concern in developing NOx sensors is sensitivity to water. Humidified gas has been shown to adversely affect NOx sensitivity.

Therefore, there is a need for NOx sensors for determining the total NOx content in a gas stream that demonstrate high sensitivity, ion conductivity, and electric response, that are insensitive to water.

### SUMMARY

Provided in the present disclosure are electrolyte compositions including a zeolite, yttria-stabilized zirconia (YSZ), and carbon nanotubes for mono-nitrogen oxide (NOx) sensors, as well as methods of preparing the electrolyte compositions, and methods of determining the total NOx content in a gas stream using said NOx sensors.

In some embodiments, the mono-nitrogen oxide (NOx) sensor includes an electrolyte composition, where the electrolyte composition includes a zeolite, yttria-stabilized zirconia (YSZ), and carbon nanotubes.

In some embodiments, the sensor further includes a counter electrode.

In some embodiments, the zeolite is selected from ZSM-5, FER, BEA, MOR, FAU, analcime, chabazite, clinoptilolite, erionite, heulandite, laumontite, natrolite, phillipsite, stilbite, and combinations thereof.

In some embodiments, the zeolite is ZSM-5.

The sensor of claim 1, the electrolyte composition comprises about 1.50% to about 2.50% zeolite by weight.

In some embodiments, the yttria-stabilized zirconia (YSZ) is selected from partly stabilized zirconia (PSZ) or fully stabilized zirconia (FSZ).

In some embodiments, the yttria-stabilized zirconia (YSZ) is selected from partially stabilized zirconia (PSZ), tetragonal zirconia polycrystal (TZP), 4 mol % Y₂O₃ partially stabilized ZrO₂ (4YSZ), fully stabilized zirconia (FSZ), cubic stabilized zirconia (CSZ), 8 mol % Y₂O₃ fully stabilized ZrO₂ (8YSZ), 8-9 mol % Y₂O₃-doped ZrO₂ (8YDZ), and combinations thereof.

In some embodiments, the yttria-stabilized zirconia (YSZ) is 8 mol % Y₂O₃ fully stabilized ZrO₂ (8YSZ).

In some embodiments, the electrolyte composition comprises from about 5% to about 10% yttria-stabilized zirconia (YSZ) by weight.

In some embodiments, the carbon nanotubes are multi-wall carbon nanotubes (MWCNT).

In some embodiments, the counter electrode comprises gold.

In some embodiments, the electrolyte composition comprises:
about 1.50% to about 2.50% zeolite;
about 7.00% to about 9.00% yttria-stabilized zirconia (YSZ); and
about 0.50% to about 1.50% carbon nanotube.

In some embodiments, the electrolyte composition comprises:
about 1.50% to about 2.50% zeolite, where the zeolite is selected from ZSM-5, FER, BEA, and MOR;
about 7.00% to about 9.00% yttria-stabilized zirconia (YSZ), where the YSZ is 8 mol % Y₂O₃ fully stabilized ZrO₂ (8YSZ);
about 0.50% to about 1.50% carbon nanotube, where the carbon nanotube is multi-wall carbon nanotube; and
a gold counter electrode.

In some embodiments, the total mono-nitrogen oxide (NOx) content in a gas including NOₓ is determined by a method including:
exposing said gas including NO_{X} to a catalytic filter thereby forming an equilibrium mixture of NO and NO₂ from said gas including NOₓ;
exposing said equilibrium mixture of NO and NO₂ to a NOₓ sensor thereby creating a potential difference, said NOₓ sensor including an electrolyte composition, where the electrolyte composition includes a zeolite, yttria-stabilized zirconia (YSZ), and carbon nanotube; and
determining the total NOₓ content in said gas including NOₓ by comparing said potential difference with a calibration curve.

In some embodiments, the sensor further including a counter electrode.

In some embodiments, the electrolyte composition includes about 1%, about 2%, about 3%, about 4%, or about 5% yttria-stabilized zirconia (YSZ) by weight.

In some embodiments, the counter electrode includes gold.

In some embodiments, the electrolyte composition includes:
about 1.50% to about 2.50% zeolite, where the zeolite is selected from ZSM-5, FER, BEA, and MOR;
about 700% to about 9.00% yttria-stabilized zirconia (YSZ), where the YSZ is 8 mol % Y₂O₃ fully stabilized ZrO₂ (8YSZ);
about 0.50% to about 1.50% carbon nanotube, where the carbon nanotube is multi-wall carbon nanotube; and
a gold counter electrode.

In some embodiments, the electrolyte composition is prepared by a process including:

providing a zeolite powder;

adding yttria-stabilized zirconia (YSZ) powder and carbon nanotube to the zeolite powder to form zeolite-Y CNT powder;

forming a slurry of the zeolite-Y CNT powder;

pressing a portion of the zeolite-Y CNT powder into a pellet; and

drying the pellet to form the electrolyte composition.

In some embodiments, the sensor is prepared by a process including:

providing a zeolite powder;

adding yttria-stabilized zirconia (YSZ) powder and carbon nanotube to the zeolite powder to form zeolite-Y CNT powder;

forming a slurry of the zeolite-Y CNT powder;

pressing a portion of the slurry of the zeolite-Y CNT powder into a pellet;

coating a counter electrode with a portion of the slurry of the zeolite-Y CNT to form a coated counter electrode;

combining the coated counter electrode with the pellet; and

drying the combined coated counter electrode and pellet to form the sensor.

### DESCRIPTION OF DRAWINGS

FIG. 1 shows a schematic for the preparation of an electrolyte composition including a zeolite and yttria-stabilized zirconia (YSZ).

FIG. 2 shows a diagram of an NO_{X} sensor including an electrolyte composition having a zeolite, yttria-stabilized zirconia (YSZ), and a gold (Au) electrode.

### DETAILED DESCRIPTION

The present disclosure relates to electrolyte compositions for mono-nitrogen oxide (NOx) sensors including a zeolite, yttria-stabilized zirconia (YSZ), and carbon nanotubes. In some embodiments, the electrolyte compositions have a combination of high sensitivity and selectivity, improved ion conductivity, and decreased sensitive to water.

Zeolites have a uniform, porous structure which includes three-dimensional channels for better ion conductivity and increase the sensitivity of the sensors. In some embodiments, incorporation of the zeolite into the electrolyte composition increases the porosity of the electrolyte composition. In some embodiments, incorporation of the zeolite into the electrolyte composition increases the surface area of the electrolyte composition. In some embodiments, incorporation of the zeolite into the electrolyte composition increases the porosity and surface area of the electrolyte composition.

In some embodiments, incorporation of the carbon nanotubes into the electrolyte composition increases the electrical conductivity. In some embodiments, incorporation of the carbon nanotubes into the electrolyte composition decreases the operational temperature range. In some embodiments, incorporation of the carbon nanotubes into the electrolyte composition increases the electrical conductivity and decreases the operational temperature range. In some embodiments, increased electrical conductivity of the electrolyte composition increases ionic activity of the electrolyte composition. In some embodiments, increased electrical conductivity of the electrolyte composition decreases the recovery rate of the electrolyte composition.

In some embodiments, the electrolyte compositions have a capacitance to NO up to about 10 ppm, about 9 ppm, about 8 ppm, about 7 ppm, about 6 ppm, about 5 ppm, about 4 ppm, about 3 ppm, about 2 ppm, or about 1 ppm from about 600° C. to about 700° C. In some embodiments, the electrolyte compositions have a capacitance to NO up to about 10 ppm from about 600° C. to about 700° C. In some embodiments, the electrolyte compositions have a capacitance to NO up to about 9 ppm from about 600° C. to about 700° C. In some embodiments, the electrolyte compositions have a capacitance to NO up to about 8 ppm from about 600° C. to about 700° C. In some embodiments, the electrolyte compositions have a capacitance to NO up to about 7 ppm from about 600° C. to about 700° C. In some embodiments, the electrolyte compositions have a capacitance to NO up to about 6 ppm from about 600° C. to about 700° C. In some embodiments, the electrolyte compositions have a capacitance to NO up to about 5 ppm from about 600° C. to about 700° C. In some embodiments, the electrolyte compositions have a capacitance to NO up to about 4 ppm from about 600° C. to about 700° C. In some embodiments, the electrolyte compositions have a capacitance to NO up to about 3 ppm from about 600° C. to about 700° C. In some embodiments, the electrolyte compositions have a capacitance to NO up to about 2 ppm from about 600° C. to about 700° C. C. In some embodiments, the electrolyte compositions have a capacitance to NO up to about 1 ppm from about 600° C. to about 700° C.

In some embodiments, the electrolyte compositions have a capacitance to NO up to about 10 ppm, about 9 ppm, about 8 ppm, about 7 ppm, about 6 ppm, about 5 ppm, about 4 ppm, about 3 ppm, about 2 ppm, or about 1 ppm at 650° C. In some embodiments, the electrolyte compositions have a capacitance to NO up to about 10 ppm at 650° C. In some embodiments, the electrolyte compositions have a capacitance to NO up to about 9 ppm at 650° C. In some embodiments, the electrolyte compositions have a capacitance to NO up to about 8 ppm at 650° C. In some embodiments, the electrolyte compositions have a capacitance to NO up to about 7 ppm at 650° C. In some embodiments, the electrolyte compositions have a capacitance to NO up to about 6 ppm at 650° C. In some embodiments, the electrolyte compositions have a capacitance to NO up to about 5 ppm at 650° C. In some embodiments, the electrolyte compositions have a capacitance to NO up to about 4 ppm at 650° C. In some embodiments, the electrolyte compositions have a capacitance to NO up to about 3 ppm at 650° C. In some embodiments, the electrolyte compositions have a capacitance to NO up to about 2 ppm at 650° C. In some embodiments, the electrolyte compositions have a capacitance to NO up to about 1 ppm at 650° C.

In some embodiments, the electrolyte compositions have a capacitance to NO₂ up to about 10 ppm, about 9 ppm, about 8 ppm, about 7 ppm, about 6 ppm, about 5 ppm, about 4 ppm, about 3 ppm, about 2 ppm, or about 1 ppm from about 600° C. to about 700° C. In some embodiments, the electrolyte compositions have a capacitance to NO₂ up to about 10 ppm from about 600° C. to about 700° C. In some embodiments, the electrolyte compositions have a capacitance to NO₂ up to about 9 ppm from about 600° C. to about 700° C. In some embodiments, the electrolyte compositions have a capacitance to NO₂ up to about 8 ppm from about 600° C. to about 700° C. In some embodiments, the electrolyte compositions have a capacitance to NO₂ up to about 7 ppm from about 600° C. to about 700° C. In some embodiments, the electrolyte compositions have a capacitance to NO₂ up to about 6 ppm from about 600° C. to about 700° C. In some embodiments, the electrolyte compositions have a capacitance to NO₂ up to about 5 ppm from about 600° C. to about 700° C. In some embodiments, the electrolyte compositions have a capacitance to NO₂ up to about 4 ppm from about 600° C. to about 700° C. In some embodiments, the electrolyte compositions have a capacitance to NO₂ up to about 3 ppm from about 600° C. to about 700° C. In some embodiments, the electrolyte compositions have a capacitance to NO₂ up to about 2 ppm from about 600° C. to about 700° C. C. In some embodiments, the electrolyte compositions have a capacitance to NO₂ up to about 1 ppm from about 600° C. to about 700° C.

In some embodiments, the electrolyte compositions have a capacitance to NO₂ up to about 10 ppm, about 9 ppm, about 8 ppm, about 7 ppm, about 6 ppm, about 5 ppm, about 4 ppm, about 3 ppm, about 2 ppm, or about 1 ppm at 650° C. In some embodiments, the electrolyte compositions have a capacitance to NO₂ up to about 10 ppm at 650° C. In some embodiments, the electrolyte compositions have a capacitance to NO₂ up to about 9 ppm at 650° C. In some embodiments, the electrolyte compositions have a capacitance to NO₂ up to about 8 ppm at 650° C. In some embodiments, the electrolyte compositions have a capacitance to NO₂ up to about 7 ppm at 650° C. In some embodiments, the electrolyte compositions have a capacitance to NO₂ up to about 6 ppm at 650° C. In some embodiments, the electrolyte compositions have a capacitance to NO₂ up to about 5 ppm at 650° C. In some embodiments, the electrolyte compositions have a capacitance to NO₂ up to about 4 ppm at 650° C. In some embodiments, the electrolyte compositions have a capacitance to NO₂ up to about 3 ppm at 650° C. In some embodiments, the electrolyte compositions have a capacitance to NO₂ up to about 2 ppm at 650° C. In some embodiments, the electrolyte compositions have a capacitance to NO₂ up to about 1 ppm at 650° C.

In some embodiments, the gas stream has a flow rate of about 10 standard cubic centimeters per minute (SCCM), about 20 SCCM, about 30 SCCM, about 40 SCCM, about 50 SCCM, about 60 SCCM, about 70 SCCM, about 80 SCCM, about 90 SCCM, about 100 SCCM, about 110 SCCM, about 120 SCCM, about 130 SCCM, about 140 SCCM, about 150 SCCM, about 160 SCCM, about 170 SCCM, about 180 SCCM, about 190 SCCM, or about 200 SCCM. In some embodiments, the gas stream has a flow rate of about 100 SCCM.

In some embodiments, the gas stream has a flow rate of about 10 standard cubic centimeters per minute (SCCM) to about 200 SCCM, about 25 SCCM to about 175 SCCM, about 50 SCCM to about 150 SCCM, or about 75 SCCM to about 125 SCCM.

The present disclosure further relates to mono-nitrogen oxide (NOx) sensors having electrolyte having a zeolite, yttria-stabilized zirconia (YSZ), and carbon nanotubes.

In some embodiments, the NOx sensors are insensitive to humidity. In some embodiments, the sensor response of the NOx sensors does not change when the relative humidity increases. In some embodiments, the sensor response of the NOx sensors does not change when the relative humidity increases from about 10% to about 90%, from about 20% to about 80%, from about 30% to about 70%, from about 40% to about 60%. In some embodiments, the sensor response of the NOx sensors does not change when the relative humidity increases from about 10% to about 90%. In some embodiments, the sensor response of the NOx sensors does not change when the relative humidity increases from about 20% to about 80%. In some embodiments, the sensor response of the NOx sensors does not change when the relative humidity increases from about 30% to about 70%. In some embodiments, the sensor response of the NOx sensors does not change when the relative humidity increases from about 40% to about 60%. In some embodiments, the sensor response of the NOx sensors does not change when the relative humidity increases while the concentration of NOx is held constant at about 200 ppm.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

The abbreviation “ZSM-5” refers to “Zeolite Socony Mobil-5” or “MFI,” an aluminosilicate zeolite having the formula NaₙAlₙSi₉₆₋ₙO₁₉₂·16 H₂O, where 0<n<27.

The abbreviation “FER” refers to “ferrierite,” a zeolite. In some embodiments, the FER is ferrierite-Mg (FER-Mg). In some embodiments, the FER is ferrierite-Na (FER-Na). In some embodiments, the ferrierite is ferrierite-K (FER-K). In some embodiments, the ferrierite is ferrierite-H (FER-H). In some embodiments, the ferrierite is Si-ferrierite (Si-FER).

The abbreviation “BEA” refers to “beta zeolite,” a high silica zeolite.

The abbreviation “FAU” refers to “faujasite” or “USY,” a high silica zeolite.

The abbreviation “MOR” refers to “high-silica mordenite,” a high silica zeolite.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Zeolites

The electrolyte compositions of the present disclosure contain a zeolite. In some embodiments, the zeolite is a porous, three-dimensional (3D) zeolite.

In some embodiments, the zeolite is a natural zeolite. In some embodiments, the zeolite is a synthetic zeolite.

In some embodiments, the zeolite is selected from ZSM-5, FER, BEA, FAU, and MOR. In some embodiments, the zeolite is ZSM-5. In some embodiments, the zeolite is FER. In some embodiments, the zeolite is BEA. In some embodiments, the zeolite is FAU. In some embodiments, the zeolite is MOR.

In some embodiments, the zeolite is selected from analcirne, chabazite, clinoptilolite, erionite, heulandite, laumontite, natrolite, phillipsite, stilbite, and combinations thereof. In some embodiments, the zeolite is analcime. In some embodiments, the zeolite is chabazite. In some embodiments, the zeolite is clinoptilolite. In some embodiments, the zeolite is erionite. In some embodiments, the zeolite is heulandite. In some embodiments, the zeolite is laurnontite. In some embodiments, the zeolite is natrolite. In some embodiments, the zeolite is phillipsite. In some embodiments, the zeolite is stilbite.

In some embodiments, the electrolyte composition includes about 0.10%, about 0.25%, about 0.50%, about 0.75%, about 1.00%, about 1.25%, about 1.50%, about 1.75%, about 2.00%, about 2.25%, about 2.50%, about 2.75%, about 3.00%, about 3.50%, about 4.00%, about 5.00%, about 10.00%, about 15.00%, or about 20.00% zeolite. In some embodiments, the electrolyte composition includes about 0.10% zeolite. In some embodiments, the electrolyte composition includes about 0.25% zeolite. In some embodiments, the electrolyte composition includes about 0.50% zeolite. In some embodiments, the electrolyte composition includes about 0.75% zeolite. In some embodiments, the electrolyte composition includes about 1.00% zeolite. In some embodiments, the electrolyte composition includes about 1.25% zeolite. In some embodiments, the electrolyte composition includes about 1.50% zeolite. In some embodiments, the electrolyte composition includes about 1.75% zeolite. In some embodiments, the electrolyte composition includes about 2.00% zeolite. In some embodiments, the electrolyte composition includes about 2.25% zeolite. In some embodiments, the electrolyte composition includes about 2.50% zeolite. In some embodiments, the electrolyte composition includes about 2.75% zeolite. In some embodiments, the electrolyte composition includes about 3.00% zeolite. In some embodiments, the electrolyte composition includes about 3.50% zeolite. In some embodiments, the electrolyte composition includes about 4.00% zeolite. In some embodiments, the electrolyte composition includes about 5.00% zeolite. In some embodiments, the electrolyte composition includes about 10.00% zeolite. In some embodiments, the electrolyte composition includes about 15.00% zeolite. In some embodiments, the electrolyte composition includes about 20.00% zeolite.

In some embodiments, the electrolyte composition includes from about 0.10% to about 20.00% zeolite, about 0.25% to about 15.00% zeolite, about 0.50% to about 10.00% zeolite, about 0.75% to about 5.00% zeolite, about 1.00% to about 3.00% zeolite, about 1.25% to about 2.75% zeolite, about 1.50% to about 2.50% zeolite, or about 1.75% to about 2.25% zeolite. In some embodiments, the electrolyte composition includes from about 0.10% to about 20.00% zeolite. In some embodiments, the electrolyte composition includes from about 0.25% to about 15.00% zeolite. In some embodiments, the electrolyte composition includes from about 0.50% to about 10.00% zeolite. In some embodiments, the electrolyte composition includes from about 0.75% to about 5.00% zeolite. In some embodiments, the electrolyte composition includes from about 1.00% to about 3.00% zeolite. In some embodiments, the electrolyte composition includes from about 1.25% to about 2.75% zeolite. In some embodiments, the electrolyte composition includes from about 1.50% to about 2.50% zeolite. In some embodiments, the electrolyte composition includes from about 1.75% to about 2.25% zeolite.

In some embodiments, the electrolyte composition includes about 0.10%, about 0.25%, about 0.50%, about 0.75%, about 1.00%, about 1.25%, about 1.50%, about 1.75%, about 2.00%, about 2.25%, about 2.50%, about 2.75%, about 3.00%, about 3.50%, about 4.00%, about 5.00%, about 10.00%, about 15.00%, or about 2.00% ZSM-5. In some embodiments, the electrolyte composition includes about 0.10% ZSM-5. In some embodiments, the electrolyte composition includes about 0.25% ZSM-5. In some embodiments, the electrolyte composition includes about 0.50% ZSM-5. In some embodiments, the electrolyte composition includes about 0.75% ZSM-5. In some embodiments, the electrolyte composition includes about 1.00% ZSM-5. In some embodiments, the electrolyte composition includes about 1.25% ZSM-5. In some embodiments, the electrolyte composition includes about 1.50% ZSM-5. In some embodiments, the electrolyte composition includes about 1.75% ZSM-5. In some embodiments, the electrolyte composition includes about 2.00% ZSM-5. In some embodiments, the electrolyte composition includes about 2.25% ZSM-5. In some embodiments, the electrolyte composition includes about 2.50% ZSM-5. In some embodiments, the electrolyte composition includes about 2.75% ZSM-5. In some embodiments, the electrolyte composition includes about 3.00% ZSM-5. In some embodiments, the electrolyte composition includes about 3.50% ZSM-5. In some embodiments, the electrolyte composition includes about 4.00% ZSM-5. In some embodiments, the electrolyte composition includes about 5.00% ZSM-5. In some embodiments, the electrolyte composition includes about 10.00% ZSM-5. In some embodiments, the electrolyte composition includes about 15.00% ZSM-5. In some embodiments, the electrolyte composition includes about 20.00% ZSM-5.

In some embodiments, the electrolyte composition includes from about 0.10% to about 20.00% ZSM-5, about 0.25% to about 15.00% ZSM-5, about 0.50% to about 10.00% ZSM-5, about 0.75% to about 5.00% ZSM-5, about 1.00% to about 3.00% ZSM-5, about 1.25% to about 2.75% ZSM-5, about 1.50% to about 2.50% ZSM-5, or about 1.75% to about 2.25% ZSM-5. In some embodiments, the electrolyte composition includes from about 0.10% to about 20.00% ZSM-5. In some embodiments, the electrolyte composition includes from about 0.25% to about 15.00% ZSM-5. In some embodiments, the electrolyte composition includes from about 0.50% to about 10.00% ZSM-5. In some embodiments, the electrolyte composition includes from about 0.75% to about 5.00% ZSM-5. In some embodiments, the electrolyte composition includes from about 1.00% to about 3.00% ZSM-5. In some embodiments, the electrolyte composition includes from about 1.25% to about 2.75% ZSM-5. In some embodiments, the electrolyte composition includes from about 1.50% to about 2.50% ZSM-5. In some embodiments, the electrolyte composition includes from about 1.75% to about 2.25% ZSM-5.

In some embodiments, the electrolyte composition includes about 0.10%, about 0.25%, about 0.50%, about 0.75%, about 1.00%, about 1.25%, about 1.50%, about 1.75%, about 2.00%, about 2.25%, about 2.50%, about 2.75%, about 3.00%, about 3.50%, about 4.00%, about 5.00%, about 10.00%, about 15.00%, or about 2.00% FER. In some embodiments, the electrolyte composition includes about 0.10% FER. In some embodiments, the electrolyte composition includes about 0.25% FER. In some embodiments, the electrolyte composition includes about 0.50% FER. In some embodiments, the electrolyte composition includes about 0.75% FER. In some embodiments, the electrolyte composition includes about 1.00% FER. In some embodiments, the electrolyte composition includes about 1.25% FER. In some embodiments, the electrolyte composition includes about 1.50% FER. In some embodiments, the electrolyte composition includes about 1.75% FER. In some embodiments, the electrolyte composition includes about 2.00% FER. In some embodiments, the electrolyte composition includes about 2.25% FER. In some embodiments, the electrolyte composition includes about 2.50% FER. In some embodiments, the electrolyte composition includes about 2.75% FER. In some embodiments, the electrolyte composition includes about 3.00% FER. In some embodiments, the electrolyte composition includes about 3.50% FER. In some embodiments, the electrolyte composition includes about 4.00% FER. In some embodiments, the electrolyte composition includes about 5.00% FER. In some embodiments, the electrolyte composition includes about 10.00% FER. In some embodiments, the electrolyte composition includes about 15.00% FER. In some embodiments, the electrolyte composition includes about 20.00% FER.

In some embodiments, the electrolyte composition includes from about 0.10% to about 20.00% FER, about 0.25% to about 15.00% FER, about 0.50% to about 10.00% FER, about 0.75% to about 5.00% FER, about 1.00% to about 3.00% FER, about 1.25% to about 2.75% FER, about 1.50% to about 2.50% FER, or about 1.75% to about 2.25% FER. In some embodiments, the electrolyte composition includes from about 0.10% to about 2.00% FER. In some embodiments, the electrolyte composition includes from about 0.25% to about 15.00% FER. In some embodiments, the electrolyte composition includes from about 0.50% to about 10.00% FER. In some embodiments, the electrolyte composition includes from about 0.75% to about 5.00% FER. In some embodiments, the electrolyte composition includes from about 1.00% to about 3.00% FER. In some embodiments, the electrolyte composition includes from about 1.25% to about 2.75% FER. In some embodiments, the electrolyte composition includes from about 1.50% to about 2.50% FER. In some embodiments, the electrolyte composition includes from about 1.75% to about 2.25% FER.

In some embodiments, the electrolyte composition includes about 0.10%, about 0.25%, about 0.50%, about 0.75%, about 1.00%, about 1.25%, about 1.50%, about 1.75%, about 2.00%, about 2.25%, about 2.50%, about 2.75%, about 3.00%, about 3.50%, about 4.00%, about 5.00%, about 10.00%, about 15.00%, or about 2.00% BEA. In some embodiments, the electrolyte composition includes about 0.10% BEA. In some embodiments, the electrolyte composition includes about 0.25% BEA. In some embodiments, the electrolyte composition includes about 0.50% BEA. In some embodiments, the electrolyte composition includes about 0.75% BEA. In some embodiments, the electrolyte composition includes about 1.00% BEA. In some embodiments, the electrolyte composition includes about 1.25% BEA. In some embodiments, the electrolyte composition includes about 1.50% BEA. In some embodiments, the electrolyte composition includes about 1.75% BEA. In some embodiments, the electrolyte composition includes about 2.00% BEA. In some embodiments, the electrolyte composition includes about 2.25% BEA. In some embodiments, the electrolyte composition includes about 2.50% BEA. In some embodiments, the electrolyte composition includes about 2.75% BEA. In some embodiments, the electrolyte composition includes about 3.00% BEA. In some embodiments, the electrolyte composition includes about 3.50% BEA. In some embodiments, the electrolyte composition includes about 4.00% BEA. In some embodiments, the electrolyte composition includes about 5.00% BEA. In some embodiments, the electrolyte composition includes about 10.00% BEA. In some embodiments, the electrolyte composition includes about 15.00% BEA. In some embodiments, the electrolyte composition includes about 20.00% BEA.

In some embodiments, the electrolyte composition includes from about 0.10% to about 20.00% BEA, about 0.25% to about 15.00% BEA, about 0.50% to about 10.00% BEA, about 0.75% to about 5.00% BEA, about 1.00% to about 3.00% BEA, about 1.25% to about 2.75% BEA, about 1.50% to about 2.50% BEA, or about 1.75% to about 2.25% BEA. In some embodiments, the electrolyte composition includes from about 0.10% to about 2.00% BEA. In some embodiments, the electrolyte composition includes from about 0.25% to about 15.00% BEA. In some embodiments, the electrolyte composition includes from about 0.50% to about 10.00% BEA. In some embodiments, the electrolyte composition includes from about 0.75% to about 5.00% BEA. In some embodiments, the electrolyte composition includes from about 1.00% to about 3.00% BEA. In some embodiments, the electrolyte composition includes from about 1.25% to about 2.75% BEA. In some embodiments, the electrolyte composition includes from about 1.50% to about 2.50% BEA. In some embodiments, the electrolyte composition includes from about 1.75% to about 2.25% BEA.

In some embodiments, the electrolyte composition includes about 0.10%, about 0.25%, about 0.50%, about 0.75%, about 1.00%, about 1.25%, about 1.50%, about 1.75%, about 2.00%, about 2.25%, about 2.50%, about 2.75%, about 3.00%, about 3.50%, about 4.00%, about 5.00%, about 10.00%, about 15.00%, or about 2.00% MOR. In some embodiments, the electrolyte composition includes about 0.10% MOR. In some embodiments, the electrolyte composition includes about 0.25% MOR. In some embodiments, the electrolyte composition includes about 0.50% MOR. In some embodiments, the electrolyte composition includes about 0.75% MOR. In some embodiments, the electrolyte composition includes about 1.00% MOR. In some embodiments, the electrolyte composition includes about 1.25% MOR. In some embodiments, the electrolyte composition includes about 1.50% MOR. In some embodiments, the electrolyte composition includes about 1.75% MOR. In some embodiments, the electrolyte composition includes about 2.00% MOR. In some embodiments, the electrolyte composition includes about 2.25% MOR. In some embodiments, the electrolyte composition includes about 2.50% MOR. In some embodiments, the electrolyte composition includes about 2.75% MOR. In some embodiments, the electrolyte composition includes about 3.00% MOR. In some embodiments, the electrolyte composition includes about 3.50% MOR. In some embodiments, the electrolyte composition includes about 4.00% MOR. In some embodiments, the electrolyte composition includes about 5.00% MOR. In some embodiments, the electrolyte composition includes about 10.00% MOR. In some embodiments, the electrolyte composition includes about 15.00% MOR. In some embodiments, the electrolyte composition includes about 20.00% MOR.

In some embodiments, the electrolyte composition includes from about 0.10% to about 20.00% MOR, about 0.25% to about 15.00% MOR, about 0.50% to about 10.00% MOR, about 0.75% to about 5.00% MOR, about 1.00% to about 3.00% MOR, about 1.25% to about 2.75% MOR, about 1.50% to about 2.50% MOR, or about 1.75% to about 2.25% MOR. In some embodiments, the electrolyte composition includes from about 0.10% to about 2.00% MOR. In some embodiments, the electrolyte composition includes from about 0.25% to about 15.00% MOR. In some embodiments, the electrolyte composition includes from about 0.50% to about 10.00% MOR. In some embodiments, the electrolyte composition includes from about 0.75% to about 5.00% MOR. In some embodiments, the electrolyte composition includes from about 1.00% to about 3.00% MOR. In some embodiments, the electrolyte composition includes from about 1.25% to about 2.75% MOR. In some embodiments, the electrolyte composition includes from about 1.50% to about 2.50% MOR. In some embodiments, the electrolyte composition includes from about 1.75% to about 2.25% MOR.

### Yttria-Stabilized Zirconia

The electrolyte compositions of the present disclosure contain a yttria-stabilized zirconia (YSZ).

In some embodiments, the yttria-stabilized zirconia (YSZ) is selected from partly stabilized zirconia (PSZ) or fully stabilized zirconia (FSZ). In some embodiments, the yttria-stabilized zirconia (YSZ) is partly stabilized zirconia (PSZ). In some embodiments, the yttria-stabilized zirconia (YSZ) is fully stabilized zirconia (FSZ).

In some embodiments, the yttria-stabilized zirconia (YSZ) is selected from partially stabilized zirconia (PSZ), tetragonal zirconia polycrystal (TZP), 4 mol % Y₂O₃ partially stabilized ZrO₂ (4YSZ), fully stabilized zirconia (FSZ), cubic stabilized zirconia (CSZ), 8 mol % Y₂O₃ fully stabilized ZrO₂ (8YSZ), 8-9 mol % Y₂O₃-doped ZrO₂ (8YDZ), and combinations thereof. In some embodiments, the yttria-stabilized zirconia (YSZ) is partially stabilized zirconia (PSZ). In some embodiments, the yttria-stabilized zirconia (YSZ) is tetragonal zirconia polycrystal (TZP). In some embodiments, the yttria-stabilized zirconia (YSZ) is 4 mol % Y₂O₃ partially stabilized ZrO₂ (4YSZ). In some embodiments, the yttria-stabilized zirconia (YSZ) is fully stabilized zirconia (FSZ). In some embodiments, the yttria-stabilized zirconia (YSZ) is cubic stabilized zirconia (CSZ). In some embodiments, the yttria-stabilized zirconia (YSZ) is 8 mol % Y₂O₃ fully stabilized ZrO₂ (8YSZ). In some embodiments, the yttria-stabilized zirconia (YSZ) is 8-9 mol % Y₂O₃-doped ZrO₂ (8YDZ).

In some embodiments, the electrolyte composition includes about 0.01%, about 0.1%, about 0.5%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, or about 25% yttria-stabilized zirconia (YSZ) by weight. In some embodiments, the electrolyte composition includes about 1% yttria-stabilized zirconia (YSZ) by weight. In some embodiments, the electrolyte composition includes about 2% yttria-stabilized zirconia (YSZ) by weight. In some embodiments, the electrolyte composition includes about 3% yttria-stabilized zirconia (YSZ) by weight. In some embodiments, the electrolyte composition includes about 4% yttria-stabilized zirconia (YSZ) by weight. In some embodiments, the electrolyte composition includes about 5% yttria-stabilized zirconia (YSZ) by weight. In some embodiments, the electrolyte composition includes about 6% yttria-stabilized zirconia (YSZ) by weight. In some embodiments, the electrolyte composition includes about 7% yttria-stabilized zirconia (YSZ) by weight. In some embodiments, the electrolyte composition includes about 8% yttria-stabilized zirconia (YSZ) by weight. In some embodiments, the electrolyte composition includes about 9% yttria-stabilized zirconia (YSZ) by weight. In some embodiments, the electrolyte composition includes about 10% yttria-stabilized zirconia (YSZ) by weight. In some embodiments, the electrolyte composition includes about 15% yttria-stabilized zirconia (YSZ) by weight. In some embodiments, the electrolyte composition includes about 20% yttria-stabilized zirconia (YSZ) by weight.

In some embodiments, the electrolyte composition includes from about 0.01% to about 25% yttria-stabilized zirconia (YSZ) by weight. In some embodiments, the electrolyte composition includes from about 0.5% to about 15% yttria-stabilized zirconia (YSZ) by weight. In some embodiments, the electrolyte composition includes from about 1% to about 12% yttria-stabilized zirconia (YSZ) by weight. In some embodiments, the electrolyte composition includes from about 5% to about 10% yttria-stabilized zirconia (YSZ) by weight. In some embodiments, the electrolyte composition includes from about 7% to about 9% yttria-stabilized zirconia (YSZ) by weight.

### Carbon Nanotubes

The electrolyte compositions of the present disclosure contain carbon nanotubes.

Carbon nanotubes (CNTs), particularly, multi-wall carbon nanotubes (MWCNTs) are a promising material for NOₓ sensing due to their high surface area, chemical stability, and electrical conductivity. When combined with zeolite, which has a porous structure and high surface area, the resulting composition material may have improved sensitivity and selectivity for NOₓ detection.

Without wishing to be bound by theory, the mechanism of NOₓ sensing with MWCNTs and zeolite may involve the adsorption of NO molecules onto the surface of the composition material. This may lead to a change in the electrical conductivity of the material, which can be measured and used to quantify the concentration of NOₓ in the surrounding environment.

In some embodiments, the carbon nanotubes are single-wall carbon nanotubes (SWCNT).

In some embodiments, the carbon nanotubes are multi-wall carbon nanotubes (MWCNT). In some embodiments, the multi-wall carbon nanotubes (MWCNT) are double-walled carbon nanotubes. In some embodiments, the multi-wall carbon nanotubes (MWCNT) are triple-walled carbon nanotubes.

In some embodiments, the electrolyte composition includes from about 0.01% to about 10.00%, about 0.10% to about 5.00%, about 0.25% to about 2.50%, about 0.50% to about 1.50%, or about 0.75% to about 1.25% carbon nanotube. In some embodiments, the electrolyte composition includes from about 0.01% to about 10.00% carbon nanotube. In some embodiments, the electrolyte composition includes from about 0.10% to about 5.00% carbon nanotube. In some embodiments, the electrolyte composition includes from about 0.25% to about 2.50% carbon nanotube. In some embodiments, the electrolyte composition includes from about 0.50% to about 1.50% carbon nanotube. In some embodiments, the electrolyte composition includes from about 0.75% to about 1.25% carbon nanotube.

In some embodiments, the electrolyte composition includes about 0.01%, about 0.10%, about 0.25%, about 0.50%, about 0.75%, about 1.00%, about 1.25%, about 1.50%, about 2.50%, about 5.00%, or about 10.00% carbon nanotube. In some embodiments, the electrolyte composition includes about 0.01% carbon nanotube. In some embodiments, the electrolyte composition includes about 0.10% carbon nanotube. In some embodiments, the electrolyte composition includes about 0.25% carbon nanotube. In some embodiments, the electrolyte composition includes about 0.50% carbon nanotube. In some embodiments, the electrolyte composition includes about 0.75% carbon nanotube. In some embodiments, the electrolyte composition includes about 1.00% carbon nanotube. In some embodiments, the electrolyte composition includes about 1.25% carbon nanotube. In some embodiments, the electrolyte composition includes about 1.50% carbon nanotube. In some embodiments, the electrolyte composition includes about 2.50% carbon nanotube. In some embodiments, the electrolyte composition includes about 5.00% carbon nanotube. In some embodiments, the electrolyte composition includes about 10.00% carbon nanotube.

In some embodiments, the electrolyte composition includes from about 0.01% to about 10.00%, about 0.10% to about 5.00%, about 0.25% to about 2.50%, about 0.50% to about 1.50%, or about 0.75% to about 1.25% multi-wall carbon nanotube. In some embodiments, the electrolyte composition includes from about 0.01% to about 10.00% multi-wall carbon nanotube. In some embodiments, the electrolyte composition includes from about 0.10% to about 5.00% multi-wall carbon nanotube. In some embodiments, the electrolyte composition includes from about 0.25% to about 2.50% multi-wall carbon nanotube. In some embodiments, the electrolyte composition includes from about 0.50% to about 1.50% multi-wall carbon nanotube. In some embodiments, the electrolyte composition includes from about 0.75% to about 1.25% multi-wall carbon nanotube.

In some embodiments, the electrolyte composition includes about 0.01%, about 0.10%, about 0.25%, about 0.50%, about 0.75%, about 1.00%, about 1.25%, about 1.50%, about 2.50%, about 5.00%, or about 10.00% multi-wall carbon nanotube. In some embodiments, the electrolyte composition includes about 0.01% multi-wall carbon nanotube. In some embodiments, the electrolyte composition includes about 0.10% multi-wall carbon nanotube. In some embodiments, the electrolyte composition includes about 0.25% multi-wall carbon nanotube. In some embodiments, the electrolyte composition includes about 0.50% multi-wall carbon nanotube. In some embodiments, the electrolyte composition includes about 0.75% multi-wall carbon nanotube. In some embodiments, the electrolyte composition includes about 1.00% multi-wall carbon nanotube. In some embodiments, the electrolyte composition includes about 1.25% multi-wall carbon nanotube. In some embodiments, the electrolyte composition includes about 1.50% Nmulti-wall carbon nanotube. In some embodiments, the electrolyte composition includes about 2.50% multi-wall carbon nanotube. In some embodiments, the electrolyte composition includes about 5.00% multi-wall carbon nanotube. In some embodiments, the electrolyte composition includes about 10.00% multi-wall carbon nanotube.

### Counter Electrodes

The electrolyte compositions of the present disclosure may further contain counter electrodes.

In some embodiments, the counter electrode includes a noble metal, a metal oxide, or a combination thereof. In some embodiments, the counter electrode includes a noble metal. In some embodiments, the counter electrode includes a metal oxide. In some embodiments, the counter electrode includes a combination of a noble metal and a metal oxide.

In some embodiments, the counter electrode includes rhenium, ruthenium, rhodium, palladium, silver, osmium, iridium, platinum, gold, Co₃O₄, CuO, MnO₂, NiO, RuO₂, V₂O₅, In₂O₃, ZnO, ZrO₂, SnO₂, W₂O₃, WO₂, WO₃, WO₅, MoO₂, MoO₃, and combinations thereof. In some embodiments, the counter electrode includes rhenium. In some embodiments, the counter electrode includes ruthenium. In some embodiments, the counter electrode includes rhodium. In some embodiments, the counter electrode includes palladium. In some embodiments, the counter electrode includes silver. In some embodiments, the counter electrode includes osmium. In some embodiments, the counter electrode includes iridium. In some embodiments, the counter electrode includes platinum. In some embodiments, the counter electrode includes gold. In some embodiments, the counter electrode includes cobalt (II, III) oxide (Co₃O₄). In some embodiments, the counter electrode includes copper (II) oxide (CuO). In some embodiments, the counter electrode includes manganese (IV) oxide (MnO₂). In some embodiments, the counter electrode includes nickel (II) oxide (NiO). In some embodiments, the counter electrode includes ruthenium (IV) oxide (RuO₂). In some embodiments, the counter electrode includes vanadium (V) oxide (V₂O₅). In some embodiments, the counter electrode includes indium (III) oxide (In₂O₃). In some embodiments, the counter electrode includes zinc oxide (ZnO). In some embodiments, the counter electrode includes zirconium dioxide (ZrO₂). In some embodiments, the counter electrode includes tin (IV) oxide (SnO₂). In some embodiments, the counter electrode includes tungsten (III) oxide (W₂O₃). In some embodiments, the counter electrode includes tungsten (II) oxide (WO₂). In some embodiments, the counter electrode includes tungsten (III) trioxide (WO₃). In some embodiments, the counter electrode includes tungsten (V) oxide (WO₅). In some embodiments, the counter electrode includes molybdenum (IV) oxide (MoO₂). In some embodiments, the counter electrode includes molybdenum (III) oxide (MoO₃).

In some embodiments, the counter electrode includes gold wire. In some embodiments, the gold wire has a diameter of from about 0.1 mm to about 0.3 mm. In some embodiments, the gold wire has a diameter of about 0.2 mm.

### Electrolyte Compositions

In some embodiments, the electrolyte composition includes:
about 1.50% to about 2.50% zeolite;
about 7.00% to about 9.00% yttria-stabilized zirconia (YSZ); and
about 0.50% to about 1.50% carbon nanotube.

In some embodiments, the electrolyte composition includes:
about 2.00% zeolite;
about 8.00% yttria-stabilized zirconia (YSZ); and
about 1.00% carbon nanotube.

In some embodiments, the electrolyte composition includes:
about 1.50% to about 2.50% zeolite, where the zeolite is selected from ZSM-5, FER, BEA, and MOR;
about 7.00% to about 9.00% yttria-stabilized zirconia (YSZ); and
about 0.50% to about 1.50% carbon nanotube.

In some embodiments, the electrolyte composition includes:
about 2.00% zeolite, where the zeolite is selected from ZSM-5, FER, BEA, and MOR;
about 8.00% yttria-stabilized zirconia (YSZ); and
about 1.00% carbon nanotube.

In some embodiments, the electrolyte composition includes:
about 1.50% to about 2.50% zeolite, where the zeolite is selected from ZSM-5, FER, BEA, and MOR;
about 7.00% to about 9.00% yttria-stabilized zirconia (YSZ), where the YSZ is 8 mol % Y₂O₃ fully stabilized ZrO₂ (8YSZ); and
about 0.50% to about 1.50% carbon nanotube, where the carbon nanotube is multi-wall carbon nanotube.

In some embodiments, the electrolyte composition includes:
about 2.00% zeolite, where the zeolite is selected from ZSM-5, FER, BEA, and MOR;
about 8.00% yttria-stabilized zirconia (YSZ), where the YSZ is 8 mol % Y₂O₃ fully stabilized ZrO₂ (8YSZ); and
about 1.00% carbon nanotube, where the carbon nanotube is multi-wall carbon nanotube.

In some embodiments, the electrolyte composition includes:
about 1.50% to about 2.50% zeolite;
about 7.00% to about 9.00% yttria-stabilized zirconia (YSZ);
about 0.50% to about 1.50% carbon nanotube; and
a counter electrode.

In some embodiments, the electrolyte composition includes:
about 2.00% zeolite;
about 8.00% yttria-stabilized zirconia (YSZ);
about 1.00% carbon nanotube; and
a counter electrode.

In some embodiments, the electrolyte composition includes:
about 1.50% to about 2.50% zeolite, where the zeolite is selected from ZSM-5, FER, BEA, and MOR;
about 7.00% to about 9.00% yttria-stabilized zirconia (YSZ), where the YSZ is 8 mol % Y₂O₃ fully stabilized ZrO₂ (8YSZ);
about 0.50% to about 1.50% carbon nanotube, where the carbon nanotube is multi-wall carbon nanotube; and
a gold counter electrode.

In some embodiments, the electrolyte composition includes:
about 2.00% zeolite, where the zeolite is selected from ZSM-5, FER, BEA, and MOR;
about 8.00% yttria-stabilized zirconia (YSZ), where the YSZ is 8 mol % Y₂O₃ fully stabilized ZrO₂ (8YSZ);
about 1.00% carbon nanotube, where the carbon nanotube is multi-wall carbon nanotube; and
a gold counter electrode.

### Methods of Preparing Electrolyte Compositions

Also provided are methods of preparing the electrolyte compositions of the present disclosure.

In some embodiments, the method of preparing the electrolyte composition includes: providing a zeolite powder;
adding yttria-stabilized zirconia (YSZ) powder and carbon nanotube to the zeolite powder to form zeolite-Y CNT powder;
forming a slurry of the zeolite-Y CNT powder;
pressing a portion of the zeolite-Y CNT powder into a pellet; and
drying the pellet to form the electrolyte composition.

In some embodiments, the drying is at room temperature. In some embodiments, the drying is at over 1000° C. In some embodiments, the drying is at 1100° C.

In some embodiments, the drying is overnight. In some embodiments, the drying is 1 hour. In some embodiments, the drying is 2 hours. In some embodiments, the drying is 3 hours. In some embodiments, the drying is 4 hours. In some embodiments, the drying is 8 hours. In some embodiments, the drying is 12 hours. In some embodiments, the drying is 24 hours. In some embodiments, the drying is 24 hours.

In some embodiments, the drying is at room temperature overnight. In some embodiments, the drying is at 1100° C. for 1 hour. In some embodiments, the drying is at room temperature overnight and then at 1100° C. for 1 hour.

### Methods of Preparing NOx Sensors

Also provided are methods of preparing the sensors of the present disclosure.

In some embodiments, the method of preparing the sensor includes:
providing a zeolite powder;
adding yttria-stabilized zirconia (YSZ) powder and carbon nanotube to the zeolite powder to form zeolite-Y CNT powder;
forming a slurry of the zeolite-Y CNT powder;
pressing a portion of the slurry of the zeolite-Y CNT powder into a pellet;
coating a counter electrode with a portion of the slurry of the zeolite-Y CNT to form a coated counter electrode;
combining the coated counter electrode with the pellet; and
drying the combined coated counter electrode and pellet to form the sensor.

### Methods of Using NOx Sensors

Also provided are methods of determining the total NOx content in a gas stream using the sensors of the present disclosure.

In some embodiments, the method of determining the total mono-nitrogen oxide (NO_{X}) content in a gas including NO_{X}, the method including:
exposing said gas including NO_{X} to a catalytic filter thereby forming an equilibrium mixture of NO and NO₂ from said gas including NOₓ;
exposing said equilibrium mixture of NO and NO₂ to a NOₓ sensor thereby creating a potential difference, said NOₓ sensor including an electrolyte composition, where the electrolyte composition includes a zeolite, yttria-stabilized zirconia (YSZ), and carbon nanotube; and
determining the total NO_{X} content in said gas including NO_{X} by comparing said potential difference with a calibration curve.

In some embodiments, the gas stream includes nitrous oxide (NO) and nitric oxide (NO₂). In some embodiments, the gas stream includes nitrous oxide (NO). In some embodiments, the gas stream includes nitric oxide (NO₂).

In some embodiments, the gas stream further includes nitrogen (N₂), oxygen (O₂), water (H₂O), hydrogen (H₂), methane (CH₄), ethane (C₂H₆), ethylene (C₂H₄), C₃₊ hydrocarbons, neon (Ne), helium (He), krypton (Kr), and combinations thereof.

### EXAMPLES

### Example 1. Preparation of Electrolyte Composition Including Zeolite and Yttria-Stabilized Zirconia

A solution having sodium aluminate and sodium hydroxide in distilled water will be prepared and combined with a solution having stoichiometric silica and aluminum hydroxide in distilled water. The combined solution will be heated in an autoclave at from about 90° C. to about 120° C. for from about 12 h to about 24 h. The resulting mixture will be filtered and the solid will be washed with water and ethanol to provide zeolite as a powder.

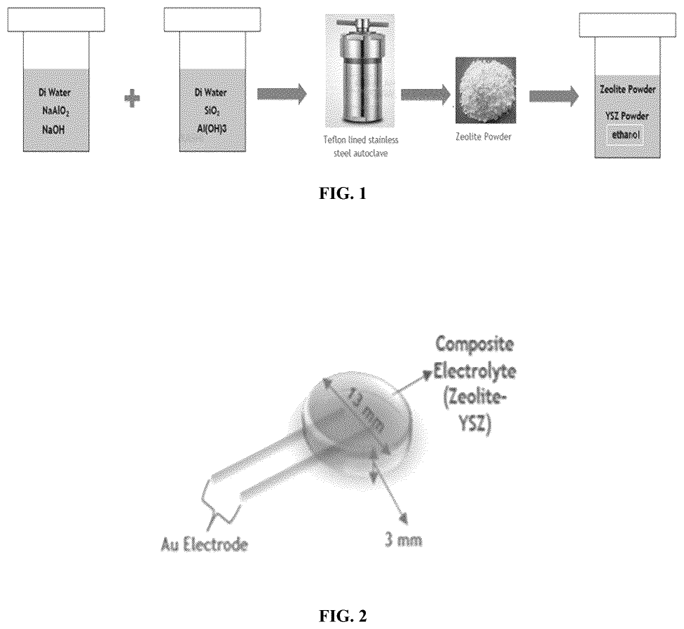

The zeolite powder will be combined with yttria-stabilized zirconia (YSZ) powder (zeolite-Y) in varying weight percentages to provide, for example, from about 1 wt % to about 15 wt % YSZ in zeolite (FIG. 1) to form zeolite Y powder. Carbon nanotubes, for example, multi-wall carbon nanotubes, will be added to the zeolite-Y powder to form zeolite-Y CNT powder. The resulting zeolite-Y powder will be ball milled in the presence of polyvinyl-butyral and ethanol to form a slurry. The resulting slurry will be air-dried. Half of the slurry will be uni-axially pressed into pellets using a Teflon-lined presser. The remaining half of the slurry will be applied to two counter electrodes (e.g., gold wire with about 0.2 mm diameter).

The coated counter electrodes will be combined with the pellets and air-dried at about 1100° C. for about 1 h to form a sensor (FIG. 2).

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A mono-nitrogen oxide (NOx) sensor comprising an electrolyte composition, wherein the electrolyte composition comprises a zeolite, yttria-stabilized zirconia (YSZ), and carbon nanotubes.

2. The sensor of claim 1, further comprising a counter electrode.

3. The sensor of claim 1, wherein the zeolite is selected from ZSM-5, FER, BEA, MOR, FAU, analcirne, chabazite, clinoptilolite, erionite, heulandite, laumontite, natrolite, phillipsite, stilbite, and combinations thereof.

4. The sensor of claim 3, wherein the zeolite is ZSM-5.

5. The sensor of claim 1, wherein the electrolyte composition comprises about 1.50% to about 2.50% zeolite by weight.

6. The sensor of claim 1, wherein the yttria-stabilized zirconia (YSZ) is selected from partly stabilized zirconia (PSZ) or fully stabilized zirconia (FSZ).

7. The sensor of claim 1, wherein the yttria-stabilized zirconia (YSZ) is selected from partially stabilized zirconia (PSZ), tetragonal zirconia polycrystal (TZP), 4 mol % Y₂O₃ partially stabilized ZrO₂ (4YSZ), fully stabilized zirconia (FSZ), cubic stabilized zirconia (CSZ), 8 mol % Y₂O3 fully stabilized ZrO₂ (8YSZ), 8-9 mol % Y₂O₃-doped ZrO₂ (8YDZ), and combinations thereof.

8. The sensor of claim 7, wherein wherein the yttria-stabilized zirconia (YSZ) is 8 mol % Y₂O3 fully stabilized ZrO₂ (8YSZ).

9. The sense of claim 1, wherein the electrolyte composition comprises from about 5% to about 10% yttria-stabilized zirconia (YSZ) by weight.

10. The sensor of claim 1, wherein the carbon nanotubes are multi-wall carbon nanotubes (MWCNT).

11. The sensor of claim 2, wherein the counter electrode comprises gold.

12. The sensor of claim 1, wherein the electrolyte composition comprises:
about 1.50% to about 2.50% zeolite;
about 7.00% to about 9.00% yttria-stabilized zirconia (YSZ); and
about 0.50% to about 1.50% carbon nanotube.

13. The sensor of claim 2, wherein the electrolyte composition comprises:
about 1.50% to about 2.50% zeolite, wherein the zeolite is selected from ZSM-5, FER, BEA, and MOR;
about 7.00% to about 9.00% yttria-stabilized zirconia (YSZ), wherein the YSZ is 8 mol % Y₂O₃ fully stabilized ZrO₂ (8YSZ);
about 0.50% to about 1.50% carbon nanotube, wherein the carbon nanotube is multi-wall carbon nanotube; and
a gold counter electrode.

14. A method of determining the total mono-nitrogen oxide (NOx) content in a gas comprising NOx, the method comprising:
exposing said gas comprising NO_{X} to a catalytic filter thereby forming an equilibrium mixture of NO and NO₂ from said gas comprising NO_{X};
exposing said equilibrium mixture of NO and NO₂ to a NOx sensor thereby creating a potential difference, said NOx sensor comprising an electrolyte composition, wherein the electrolyte composition comprises a zeolite, yttria-stabilized zirconia (YSZ), and carbon nanotube; and
determining the total NO_{X} content in said gas comprising NO_{X} by comparing said potential difference with a calibration curve.

15. The method of claim 14, wherein the sensor further comprising a counter electrode.

16. The method of claim 14, wherein the electrolyte composition comprises about 1%, about 2%, about 3%, about 4%, or about 5% yttria-stabilized zirconia (YSZ by weight.

17. The sensor of claim 14, wherein the counter electrode comprises gold.

18. The method of claim 14, wherein the electrolyte composition comprises:
about 1.50% to about 2.50% zeolite, wherein the zeolite is selected from ZSM-5, FER, BEA, and MOR;
about 7.00% to about 9.00% yttria-stabilized zirconia (YSZ), wherein the YSZ is 8 mol % Y₂O₃ fully stabilized ZrO₂ (8YSZ);
about 0.50% to about 1.50% carbon nanotube, wherein the carbon nanotube is multi-wall carbon nanotube; and
a gold counter electrode.

19. A method of preparing an electrolyte composition, comprising:
providing a zeolite powder;
adding yttria-stabilized zirconia (YSZ) powder and carbon nanotube to the zeolite powder to form zeolite-Y CNT powder;
forming a slurry of the zeolite-Y CNT powder;
pressing a portion of the zeolite-Y CNT powder into a pellet; and
drying the pellet to form the electrolyte composition.

20. A method of preparing a sensor, comprising:
providing a zeolite powder;
adding yttria-stabilized zirconia (YSZ) powder and carbon nanotube to the zeolite powder to form zeolite-Y CNT powder;
forming a slurry of the zeolite-Y CNT powder;
pressing a portion of the slurry of the zeolite-Y CNT powder into a pellet;
coating a counter electrode with a portion of the slurry of the zeolite-Y CNT to form a coated counter electrode;
combining the coated counter electrode with the pellet; and
drying the combined coated counter electrode and pellet to form the sensor.
